(19) United States
(12) Patent Application Publication
(10) Pub. No.: US 2009/0181857 A1
(43) Pub. Date: Jul. 16, 2009

(54) System and method for producing a label-free micro-array biochip

(75) Inventors: Pei-Kuen Wei, Taipei (TW); Kuang-Li Lee, Keelung City (TW)

Correspondence Address: COHEN, PONTANI, LIEBERMAN & PAVANE LLP, 551 FIFTH AVENUE, SUITE 1210, NEW YORK, NY, 10176, US

(73) Assignee: Academia Sinica, Nankang Teipei (TW)

(21) Appl. No.: 12/319,612

(22) Filed: Jan. 9, 2009

Related U.S. Application Data
(60) Provisional application No. 61/011,291, filed on Jan. 15, 2008.

(51) Int. Cl. C40B 30/04; C40B 50/14

(52) U.S. Cl. 506/9; 506/30

(57) ABSTRACT

A system and method for producing label-free micro-array biochip based on the surface plasmon resonance in metallic nano-slit arrays, wherein the micro-array biochip of the does not utilize fluorescent labeling. Without the fluorescence labeling, the label-free micro-array substantially reduces the sample cost and can detect bio-molecular interactions in their native forms.

### CROSS-REFERENCE TO RELATED APPLICATIONS

This application claims priority from U.S. Provisional Application Ser. No. 61/011,291 filed Jan. 15, 2008, the disclosure content of which is hereby incorporated by reference in its entirety.

### BACKGROUND OF THE INVENTION

1. Field of the Invention

The present invention generally relates to the field of micro-arrays and, more particularly, to a system and method for producing a label-free micro-array biochip.

2. Description of the Related Art

Optical excitation of surface plasmons (SPs) on a thin metallic surface is widely applied in the context of sensitive biosensing. This conventional approach to biosensing utilizes attenuated total reflection (ATR) in a glass prism to excite an SP wave on a thin gold film that is coated on the prism. It is known that ATR biosensors are very sensitive to surface environmental changes. Consequently, it is possible to measure the change of the surface refractive index unit (RIU) to the order of 106 to obtain a precise angular measurement (1×10⁻⁴ degrees) or 2×10⁻⁵ for 0.02 nm wavelength shift in the optical spectrum (see J. Homola et al. “Surface plasmon resonance sensors: review”, Sens. Actuators B 54, 3-15 (1999)). However, the ATR setup that is used to perform such measurements is typically bulky, expensive and requires a large amount of sample solution. Due to the optical configuration of the ATR setup, it is difficult to apply such a setup to perform high-throughput and chip-based detections in devices such as DNA and protein micro-arrays.

Prior studies of modern nano-plasmonics have determined that SPs can also be excited by metallic nanostructures (see T. W Ebbesen et al. “Extraordinary optical transmission through sub-wavelength hole arrays,” Nature 391, 667-669 (1998)). The resonance of SP waves in a periodic nano-structure causes extraordinary transmission in certain wavelengths. In this case, the resonance of SP is sensitive to the condition of the surface of the nano-structure. As a result, metallic nano-structures can also be used for label-free detections. A. G. Brolo et. al. have proved this concept by using an array of nano-holes in a 200 nm-thick gold film, as shown in FIG. 1(a) (see A. G. Brolo et al. “Surface Plasmon Sensor Based on the Enhanced Light Transmission through Arrays of Nano-holes in Gold Films”, Langmuir 20, 4813-4815 (2004)). Here, a sensitivity of 400 nm/RIU was achieved by measuring the resonant wavelength shift. In addition, light is cut-off in the nano-holes in the nano-hole array. However, the enhanced transmission is attributable to the surface plasmon resonance (SPR) on the top and bottom-sides of the metallic film.

The resonance occurs when the incident wavelength and the period of the nanostructure satisfies the phase matching condition of the following relationship:

$$λ = \frac{a}{\sqrt{{i}^{2} + {j}^{2}}} \sqrt{\frac{ɛ \times {n}^{2}}{( ɛ + {n}^{2} )}} \qquad Eq . 1$$

where a is the period of the array, λ is the incident wavelength, n is the refractive index on the surface, ε is the dielectric constant of metal, and i, j are integers, denoting the mode numbers.

In a glass biochip, the refractive indices of the substrate (n˜1.5) and outside air (n=1) or water environment (n˜1.32) have different phase matching conditions. The coupling between both of the bottom-side and top-side SPR modes is quite low. As a result, a low level of enhancement with respect to the optical transmission occurs.

### SUMMARY OF THE INVENTION

Disclosed are a system and method for producing a label-free micro-array biochip based on the surface plasmon resonance in metallic nano-slit arrays. Modern micro-arrays are required to use fluorescent dyes to label the bio-molecules of the micro-arrays. In contrast, however, the micro-array biochip of the invention does not utilize fluorescent labeling. Without the fluorescence labeling, the label-free micro-array substantially reduces the sample cost and can detect bio-molecular interactions in their native forms.

The disclosed label-free micro-array chip comprises metallic nano-slit arrays. Here, the thickness of the metallic film is about 100 nm, where the opening of the slit is smaller than 100 nm. In addition, the size of each array size is approximately 100 μm, with the separation distance between adjacent arrays also being approximately 100 μm. This dimension is comparable with the spot size and separation in a DNA microarray. As a result, it is possible to place tens of thousands of detection points on a standard glass slide.

When a transverse magnetic (TM) polarized normally incident light is focused on the nano-slit arrays, the light generates surface plasmonic waves in the nanoslits. At a specific wavelength, the surface plasmons are in resonance and the optical transmission is enhanced. The resonant condition is highly dependent upon the surface condition. As a result, bio-molecular interactions on the chip surface can be detected from the transmission light with a high degree of sensitivity.

The present inventors have utilized two methods to detect the bio-molecular interactions. In the first method, the transmission spectra is read from each nano-slit array. Here, the transmission peak wavelength is “red-shifted” when bio-molecules are attached on the surface of the array.

The second method entails recording intensity changes. Here, the shift of wavelength causes a decrease of the transmission intensity. High throughput bio-molecular interactions can be simultaneously measured by using a low-noise charged coupled device (CCD).

The disclosed label-free micro-array biochip may be used in micro-array biochips, such as for DNA micro-arrays, protein micro-arrays or aptamer micro-array, or in high throughput antibody-antigen studies. The disclosed label-free micro-array biochip provides advantages over existing technologies, such as modification and fluorescence labeling on the analyte is not required, the label-free micro-array biochip is ultra-sensitive, the micro-array presents a simple optical reading system and may be easily used in high throughput studies.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1(a) is an illustration of a nano-hole array;

FIG. 1(b) is an illustration of a nano-slit array;

FIG. 2 is a graphical plot of the transmission spectra of a nano-slit array for TE and transverse magnetic (TM) polarized waves;

FIG. 3 is a graphical plot of the calculated optical mode profiles for the surface plasmon resonance (SPR) mode and the cavity mode of a nano-slit array;

FIG. 4 is an illustration of the structural arrangement of a label free micro-array in accordance with the invention;

FIG. 5 is a scanning electron microscope image of a nano-slit array;

FIG. 6 is a schematic block diagram of a system for performing spectrum measurements of the label-free micro-array of FIG. 4;

FIG. 7 is a graphical plot of the measured bovine serum albumin (BSA) and anti-BSA of a nano-slit array; and

FIG. 8 is a schematic block diagram of an optical system for performing intensity measurements of the label-free micro-array of FIG. 4.

### DETAILED DESCRIPTION OF THE EXEMPLARY EMBODIMENT

Disclosed are a system and method for producing a label-free micro-array biochip. Modern micro-arrays require fluorescent dyes to permit signal detections. However, the fluorescent labeling substantially increases the sample costs. In addition, the fluorescent causes problems when studying protein-protein interactions. In accordance with the invention, nano-plasmonics are used in metallic nano-structures as a sensing element. Here, the resonance of the plasmonics is highly sensitive to the surface conditions. The resonance of the plasmonics can be used to simultaneously study multiple interactions between an analyte and a probe.

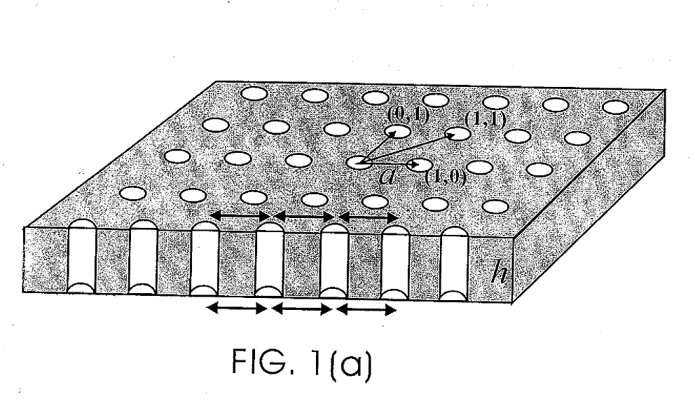

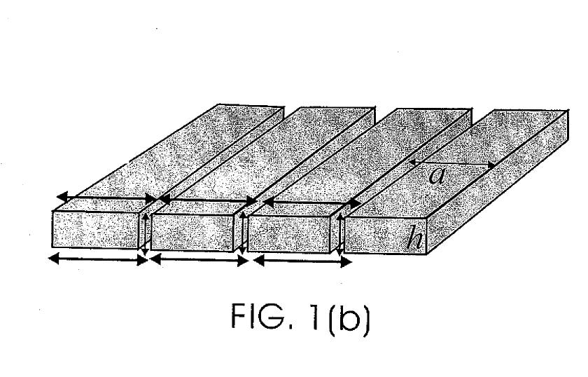

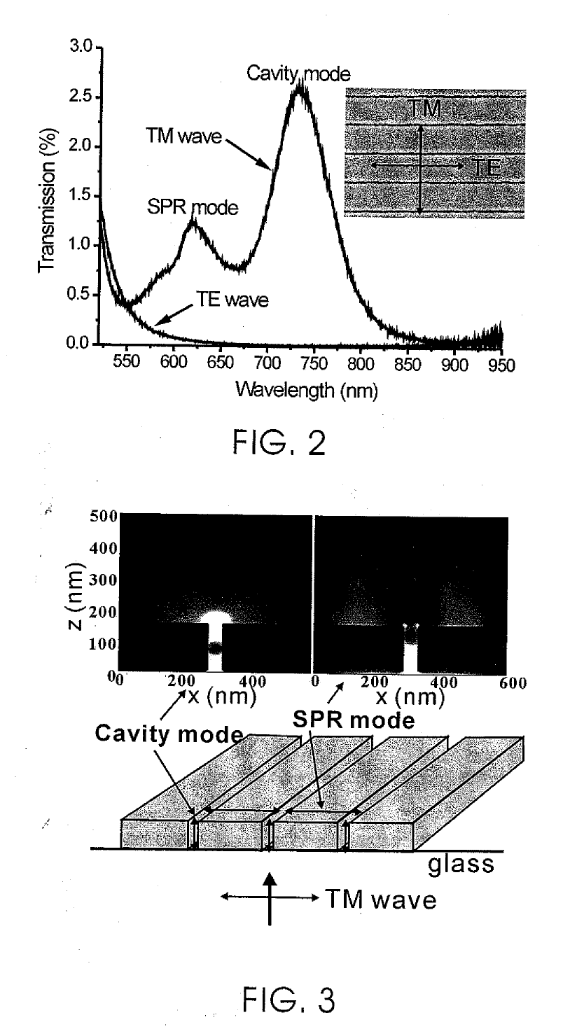

Much differently from the nano-hole structures, the present inventors have determined that transverse-magnetic (TM) polarized wave can transmit through nano-slits without cut-off (see Pei-Kuen et al. “Optical near-field in nano metallic slits”, Optics Express, 10, p. 1418 (2002). Here, the none cut-off behavior is attributable to the surface plasmons (SPs) generated in the metallic nano-meter gaps. The SPs can propagate in the nano-slits and on the outside metallic surface. Extraordinary transmission of the TM wave occurs when the SPs are resonant in the slit gap or on the outside surface, as shown in FIG. 1(b). The optical transmission spectrum for a typical nanoslit array with 600 nm-period, 150 nm-thickness of gold film and 50 nm-slit gap is shown in FIG. 2.

For a TE-polarized incident wave, there is no extraordinary transmission of light. Here, the optical transmission is decreased with the incident wavelength. For a TM-polarized wave, however, there are two transmission peaks in the transmission spectrum. One is the surface plasmon (SPR) mode, where SP waves are resonant on the outside surface. This transmission peak (λ˜635 nm) can be predicted quite accurately by Eq. (1), where a=600 nm, ε=−10, and (i,j)=(1,0). The other transmission peak is the resonance of SP waves in the nanogap (λ˜750 nm). This mode has a higher transmission than the SPR mode, and is a cavity mode that is formed by multiple reflections between the interface of the top and bottom surface. The finite-difference time-domain (FDTD) method may be used to calculate optical mode profiles (see Taflove et al. “Computational electrodynamics: the finite-difference time-domain method”, Artech House, Boston, 2000, 2^{nd} Ed.).

FIG. 3 is a graphical plot of the calculated optical mode profiles for the surface plasmon resonance (SPR) mode and the cavity mode of a nano-slit array. With reference to FIG. 3, shown therein is the calculated mode profiles, where the graphical plots verify that the SPR mode is resonant on the outside surface and the cavity mode is resonant in the slit gap.

It is known that both SP resonances can be used to perform label-free detections. App. Phys. Lett. 90, 233119 (2007) describes that the cavity mode has a much higher surface sensitivity (see Kuang-Li et al. “Sensitive Detection of Nanoparticles using Metallic Nanoslit Arrays”, App. Phys. Lett. 90, 233119 (2007)). As a result, high-throughput and a much more sensitive label-free microarray can be made by using the cavity mode in the nano-slit arrays.

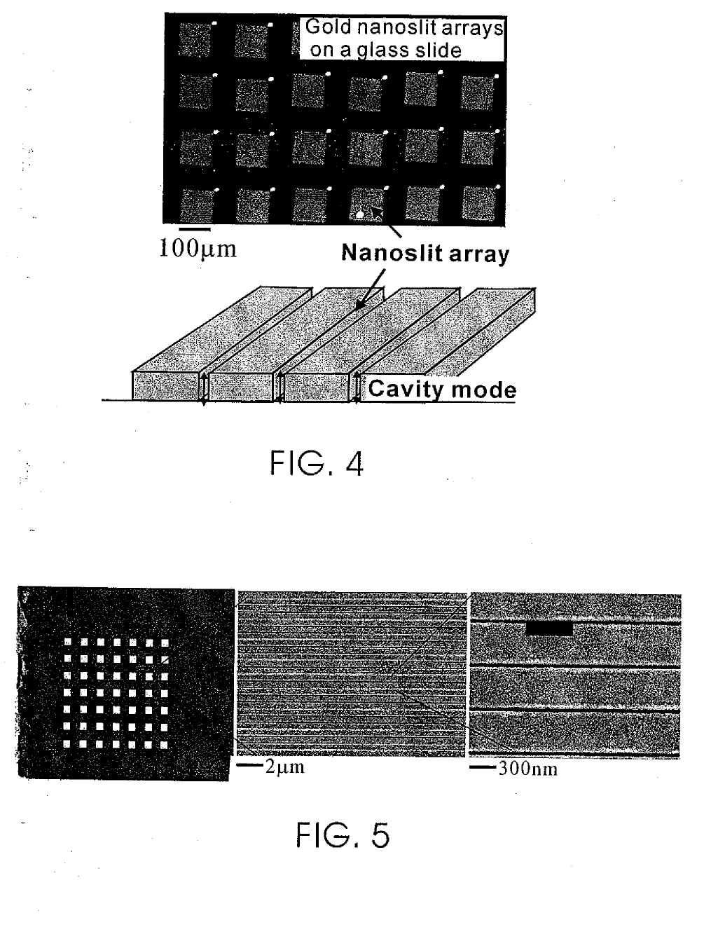

FIG. 4 is an illustration of the layout of a label-free micro-array in accordance with the invention. With specific reference to FIG. 4, layout of the label-free micro-array is shown, where the substrate is a transparent slide, such as a glass slide, mica as or polymethylmethacrylate (acrylic) (PMMA). Multiple nano-slit arrays are fabricated on this substrate. Here, each size of the nano-slit array is approximately 100 μm. The separation between adjacent arrays is also about 100 μm. It should be appreciated that the provided dimensions are exemplary and it is not the intention to limit the disclosed label-free micro-array to these specific dimensions, and that other dimensions may be implemented. In any event, the present disclosed dimension is comparable with the spot size and separation in a DNA micro-array. As a result, it is possible to manufacture tens of thousands of detection regions on a glass slide.

The nano-slit arrays are made on a metallic thin-film with periodic nano-slits. Here, the period of the slits is in the order of, for example, approximately several hundred microns, with the slit-gap being smaller than, for example, 100 nm.

In accordance with the method of the invention, different kinds of bio-molecules are first immobilized on the surface of the micro-array. The format of the label-free micro-array is the same as the formation in a DNA micro-array. As result, it is possible to utilize the established technology for micro-array spotting to place these different bio-molecules on the surface of the slide. In accordance with the method of the invention, the bio-molecules may constitute probes.

Next, the bio-molecular interactions between a bio-sample and the probes are detected by mixing the bio-sample with the label-free micro-array. After a predetermined time that the bio-sample with the label-free micro-array interact, the micro-array is washed by a clean buffer solution. If the bio-sample has bio-affinity to some of the probes, it will be fixed on these probes. However, other probes without bio-affinity to the bio-sample will remain at the same surface condition. Upon reading the surface plasmon signals, it is possible to determine or indicate the bio-affinities between the bio-sample and the probes.

In an aspect of the method of the invention, a label-free micro-array chip is created for use in reading the surface plasmon signals. Here, metallic nano-slit arrays are fabricated by using electron beam lithography and reactive ion etching. A soda-lime glass is used as the substrate. Gold has a poor level of adhesion to a glass surface. As a result, a 5 nm-thick Ti film and 150 nm-thick gold film are sequentially deposited on the glass sample by using an electron gun evaporator. FIG. 5 shows the scanning electron microscope (SEM) images of the nano-slit array. With specific reference to FIG. 5, each array comprises 600 nm-period and 50 nm-gap nano-slits. Here, the area of a nano-slit array is approximately 100 μm×100 μm. The transmission spectrum for a single array may be tested by using a white light source, such as a 12 watt, halogen lamp.

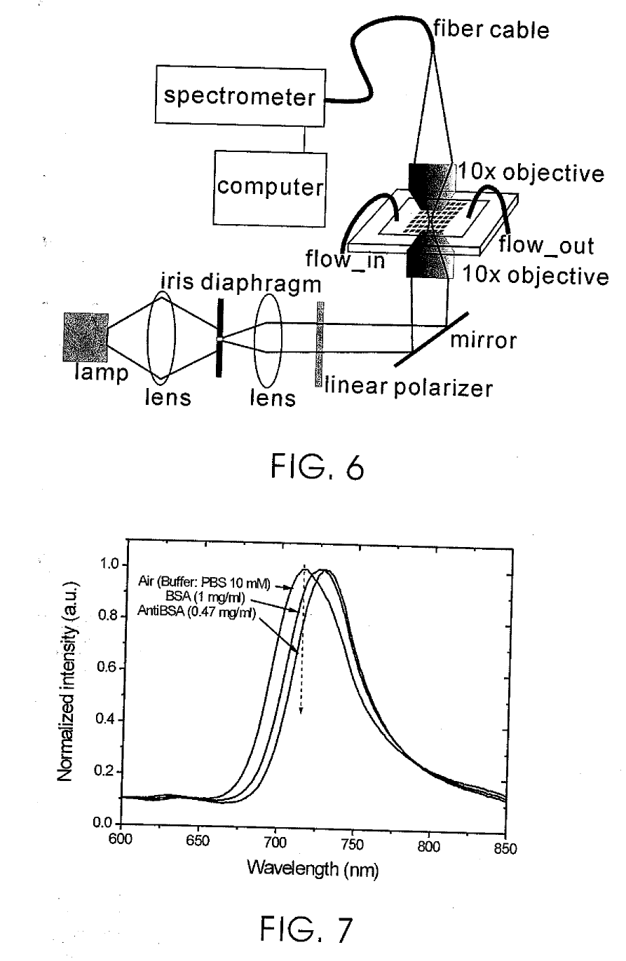

FIG. 6 is a schematic block diagram of a system for performing spectrum measurements of the label-free micro-array, i.e., FIG. 6 shows the steps for performing optical measurements. Here, the light is spatially filtered by using a lens, an iris diaphragm and a collimation lens. In addition, incident polarization is controlled by the use of a linear polarizer. Next, the polarized light is focused on a single array by using a 10× objective lens. It should be noted that the beam size focused on the micro-array needs to be smaller than 100 μm to avoid the influence from other arrays. Focusing of the beam size to the required sized can be accomplished by adjusting the aperture size of the iris diaphragm. The transmission light is then collected by another 10× objective and focused on a fiber cable. The measurement of the transmission spectrum is obtained by using a fiber coupled linear CCD array spectrometer.

FIG. 7 is a graphical plot of the measured bovine serum albumin (BSA) and anti-BSA of a nano-slit array, i.e., FIG. 7 illustrates an exemplary antigen-antibody interaction measured by a nano-slit array in a chip. Here, the film thickness is, for example, approximately 130 nm and the slit gap is, for example, approximately 60 nm. It should be appreciated that the provided dimensions are exemplary and it is not the intention to limit the disclosed label-free nano-slit to dimensions of this specific size and that other dimensions may be implemented. In accordance with the method of the invention, the chip is initially washed by a phosphate buffer saline (PBS) solution. Here, the chip exhibited a resonant peak at a wavelength of 715 nm. Next, the bovine serum albumin (BSA) protein is immobilized on the nano-slit array. Here, the BSA antigen causes a “red-shift” of the cavity mode, i.e., the cavity mode is moved to a wavelength of 725 nm. Next, the anti-BSA protein is placed on the nano-slit array.

A predetermined time period of interaction is allowed to pass, after which the chip is washed by the PBS solution and blown dry with nitrogen. In the preferred embodiment, the interaction time is one hour. The anti-BSA and BSA interaction exhibited a 3.5 nm red-shift of the spectrum. From the wavelength shift of the peak transmission, the bio-molecular interaction is directly measured with a high level of sensitivity. For the detection of multiple nano-slit arrays, a two-axis X-Y motorized micro-stage is used to automatically move the arrays to the measurement region.

In addition to the red-shift of the wavelength, it should be noted that the transmission intensity is substantially decreased at the resonant wavelength. As shown in FIG. 7, the normalized intensity (intensity=1) at 715 nm is decreased to 0.91 when the BSA is immobilized on the nano-slit array. Here, the anti-BSA and BSA interaction cause a further decrease of the intensity, where the wavelength becomes 0.8 at 715 nm. As a result, it is apparent that not only the red-shift of the wavelength but also the intensity change at the original resonant wavelength may be used as the surface plasmon signal.

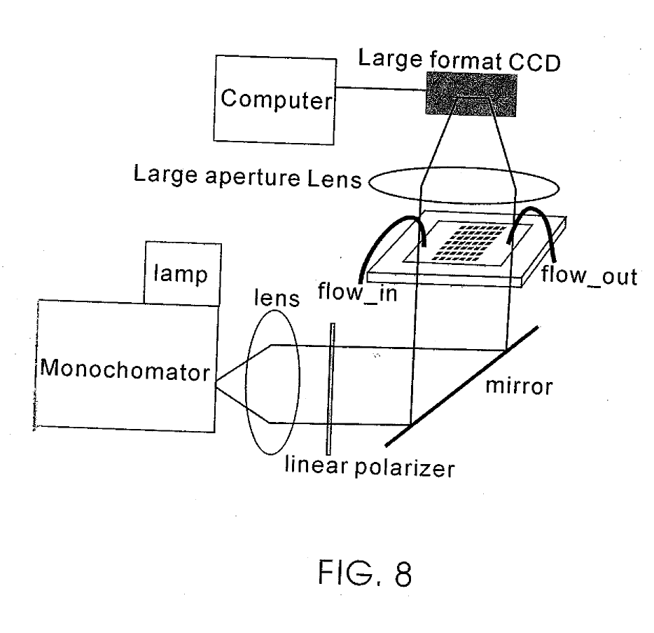

FIG. 8 is a schematic block diagram of an optical system for performing intensity measurements of the label-free micro-array of FIG. 4, i.e., FIG. 8 shows the optical setup for performing intensity measurements. In accordance with the method of the invention, a mono-chromator is used to choose the incident wavelength at the original resonant wavelength. Here, the single wavelength light source is normally incident to the label-free biochip. A lens is used to collect the transmission light through the micro-array, and project it to a low-noise CCD. Here, the CCD simultaneously records the intensities at nano-slit arrays. From the intensity changes of transmission light, bio-molecular interactions are directly read and compared. The intensity measurement is simple in the optical system. Such a measurement does not require the micro-stages to move the biochip. Moreover, the system easily performs high throughput detections and may be applied in kinetic studies of bio-molecular interactions.

Thus, while there are shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for producing a label-free micro-array biochip, comprising:
immobilizing a plurality of different kinds of bio-molecules on a surface of the micro-array biochip;
mixing a bio-sample with the label-free micro-array to detect bio-molecular interactions between the bio-sample and the plurality of different kinds of bio-molecules;
cleaning the label-free micro-array biochip with a buffer solution after a predetermined time of interaction between the bio-sample and the label-free micro-array; and
reading surface plasmon signals of the label-free micro-array biochip to determine bio-affinities between the bio-sample and the plurality of different kinds of bio-molecules.

2. The method of claim 1, wherein the label-free micro-array comprises a plurality of nano-slit arrays.

3. The method of claim 1, wherein metals for the nano-slit arrays comprise gold, silver or aluminum.

4. The label-free micro-array of claim 3, wherein a thickness of the metals is approximately 100 nm.

5. The label-free micro-array of claim 3, wherein a nano-slit array includes a period of several hundred microns, and a slit gap is smaller than 100 nm.

6. The label-free micro-array of claim 1, wherein a substrate of the label free micro-array is a transparent material.

7. The label-free micro-array of claim 6, wherein the substrate is one of a glass slide, PMMA and mica.

8. The label-free micro-array of claim 1, wherein surface plasmon signals are read from a cavity mode of multiple nano-slit arrays.

9. The label-free micro-array of claim 8, wherein the cavity mode has a higher optical transmission and sensitivity.

10. The label-free micro-array of claim 8, wherein the surface plasmon signals are read from a wavelength shift.

11. The label-free micro-array of claim 8, wherein the surface plasmon signals are read from intensity changes at a fixed wavelength.

12. A method for measuring antigen-antibody interaction in a nano-slit array in a label-free micro-array biochip, comprising:
washing the label-free micro-array biochip with a buffer solution;
immobilizing a bovine serium albumin (BSA) on the nano-slit array;
placing an anti-bovine serium albumin (anti-BSA) on the nano-slit array;
allowing the BSA and anti-BSA to interact on the nano-slit array for a predetermined period of time;
re-washing the nano-slit array having the BSA and anti-BSA with the buffer solution and drying the nano-slit array; and
directly measuring a wavelength shift of a cavity mode of the nano-slit array to determine the interaction of the antigen-antibody.

13. The method of claim 12, wherein a thickness of the nano-slit array is 130 nm and a slit is approximately 60 nm.

14. The method of claim 12, wherein the predetermined period of time is approximately one hour.

15. The method of claim 12, wherein the BSA and anti-BSA interaction exhibits a 3.5 nm spectrum red-shift.

16. The method of claim 12, wherein transmission intensity is substantially decreased at a resonant wavelength.

17. The method of claim 12, wherein a normalized intensity at 715 nm is decreased to 0.91 when the BSA is immobilized on the label free nano-slit array.

18. The method of claim 12, wherein the label-free micro-array biochip has a resonant peak at a wavelength of 715 nm.
